(19) United States
(12) Patent Application Publication
(10) Pub. No.: US 2005/0066557 A1
(43) Pub. Date: Mar. 31, 2005

(54) Alterated copies

(76) Inventors: Gersh Korsinsky, Brooklyn, NY (US); Eduard Korsinsky, Brooklyn, NY (US); Michael Korsinsky, Brooklyn, NY (US)

Correspondence Address: GERSH KORSINSKY, 1236 49th STREET, APARTMENT 4B, BROOKLYN, NY, 11219, US

(21) Appl. No.: 10/672,567

(22) Filed: Sep. 29, 2003

(51) Int. Cl. G09F 3/02

(52) U.S. Cl. 40/27.5

(57) ABSTRACT

The alternation of a copy of antiques or coins that instance of being different from the Original.

### FIELD OF THE INVENTION

The present invention is related to religious articles, and/or historical articles, and/or memorial articles, and/or gift, etc. And more specifically to antiqueness and coins that qualified as a holy or historical values articles which were used them in religious ceremonies.

### BACKGROUND OF THE INVENTION

The disadvantages of the known holy antiqueness and coins are that they not complied with the religious requirements by placed image, or by material use for them or by weight values of them, etc. caused by the historical or other factors on the holy land.

Therefore, the holy antiqueness and coins were used a short time and then were abandoned from use in religious ceremonies as a holy article, so that the known holy antiqueness and coins are not suitable to use in religious ceremonies.

The known holy coins were mint in small numbers with large changes. Therefore, the coins and antiqueness were used only for collection trading and the government laws protected them for reproduction and copying.

Therefore, the production was impossible into difference government restrictions during the thousand years period. A drawback of the known holy antiqueness and coins is that they tend be as articles for collection only. However, the known antiqueness and coins will not solve the modem problems of use them as a holy article in religious ceremonies.

### OBJECT OF THE INVENTION

It is an object of the present invention to altered the religious antiqueness and coins that suitable for religious ceremonies.

It is another object of the invention to altered the religious antiqueness and coins that comply with collections trading laws and copyrights laws.

Yet is another object of the invention to altered the holy antiqueness and coins to higher the holy values of them.

A future object of the invention is to alternate the holy antiqueness and coins to save the historical values of them.

Still another object of the invention is to alternate that save the identical image of them.

Yet is another object of the invention to alternate the holy antiqueness and coins that save the original type of production them.

It is object of the invention to alternate them that suitable for copyright protection.

The object of the invention is to alternate the holy antiqueness and coins that suitable to create a historical values of the Jerusalem and other holy places.

Yet another object of the invention is to alternate the holy antiqueness and coins that create serial values of them.

### DETAILED DESCRIPTIONS OF PREFERED EMBODIMENTS

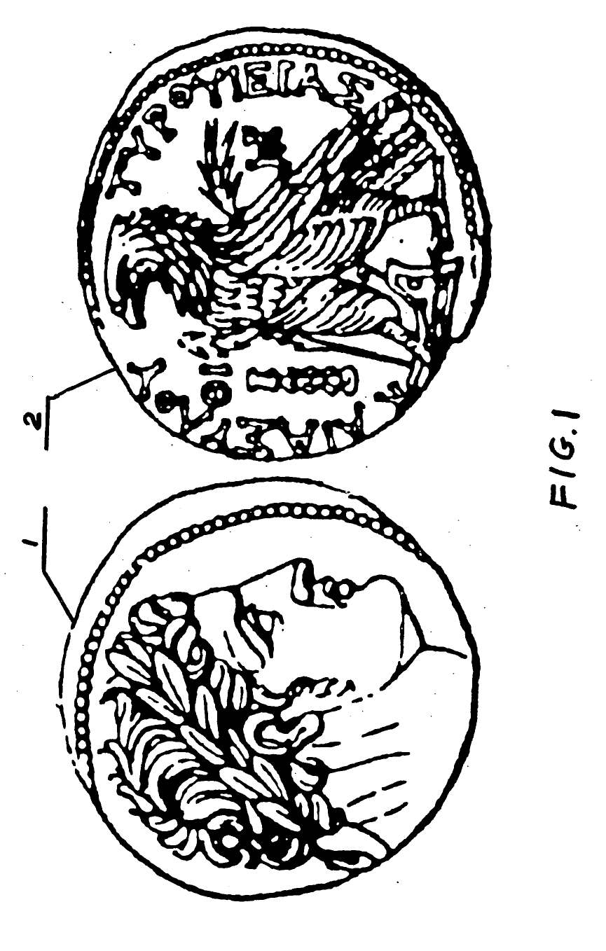

The FIG. 1-FIG. 7 shows the basic principles for designing alterations of copies of a real antiquaries and coins.

FIG. 1 shows the original of the coin “SHEKELS OF TYRE.

Shekels of Tyre;

Struck in Tyre

AR Shekel.
O: Laureate head of Melqarth r., wears lion skin knotted around neck.
R: Eagle standing left with right foot on prow of ship, palm branch over right shoulder, date and club are in field to left, a Phoenician letter between eagle's legs, in right field are letters or monogram; inscription, TYPOYIEPAI KAIAY.YAOY (of Tyre the holy and inviolable). The dates range from A (126-5 B.C.E.) to PZ (19-18 B.C.E.).

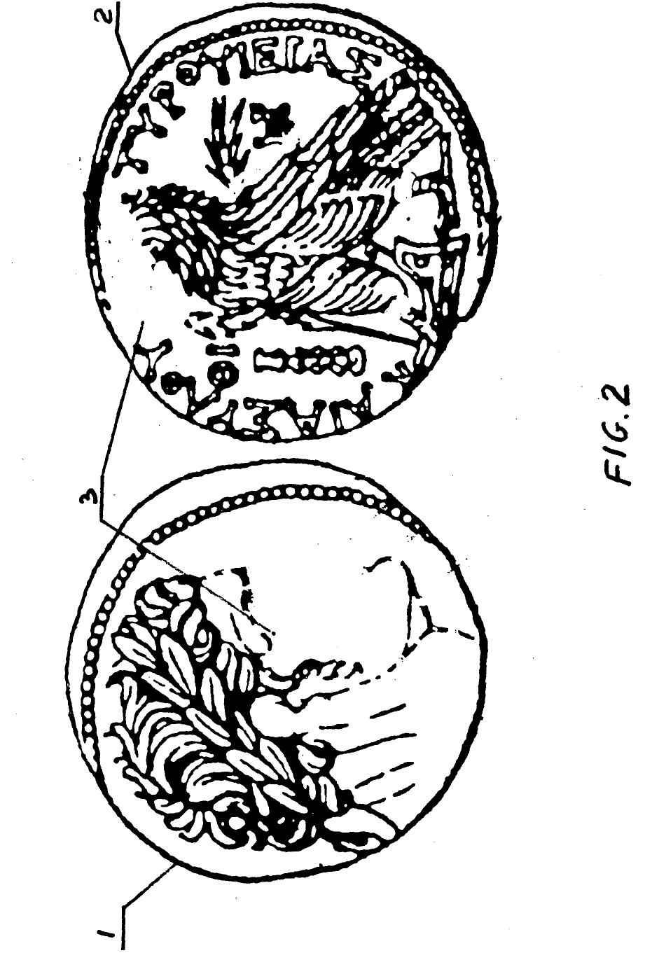

FIG. 2 shows an example of basic principles for designing alteration of a copy.
1. Copy of a real coin “SHEKEL OF TYRE”
2. The material of the copy is silver.
3. A same image is removed by religion reason.
4. Image in original Torah script. [symbol]
5. Image in original of the coins original script. sacred shekel
6. Image in original Torah script. [symbol] [symbol]
7. Image in original coin script. shekel is twenty geras
8. Image in original Torah script [symbol]
9. Hebrew year of the original in Torah script.
10. Hebrew year of the copy in Torah script.
11. Hebrew year of the original in coin script.
12. Hebrew year of the copy in coin script.
13. The year of the original in coin script.
14. The year of the copy in coin script.
15. Image “SILVER” in coin language and script.
16. “SERIAL NUMBER, PROBE, SILVER, WEIGHT IN GR.” in understandable language and script.
17. The year of the copy, patent No., “Struck in TYRE” of the original in understandable language.
18. ETC.

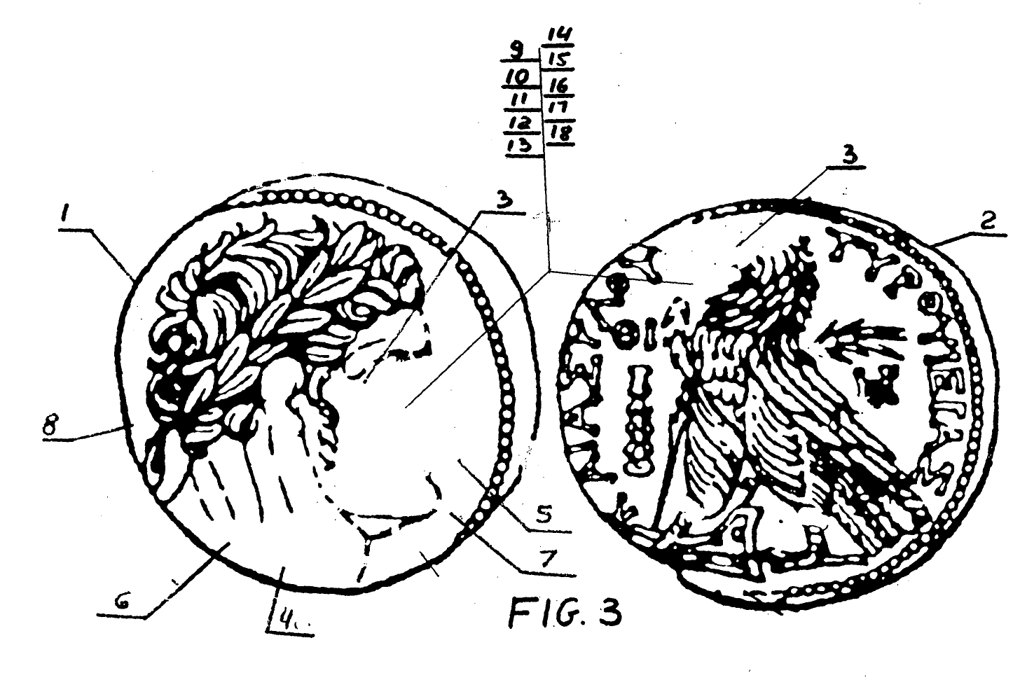

FIG. 3 shows other example “HALF SHEKEL”
1. Copy of a real coin “half shekel”.
2. The material of the copy is silver.
3. A same image is removed by religion reason.
4. Image in original Torah script. [symbol] z,6
5. Image in original of the coins original script. half shekel of the sacred shekel
6. Image in original Torah script. [symbol] [symbol]
7. Image in original coin script. shekel is twenty geras
8. Image in original Torah script [symbol]
9. Hebrew year of the original in Torah script.
10. Hebrew year of the copy in Torah script.
11. Hebrew year of the original in coin script.
12. Hebrew year of the copy in coin script.
13. The year of the original in coin script.
14. The year of the copy in coin script.
15. Image “SILVER” in coin language and script.
16. “SERIAL NUMBER, PROBE, SILVER, WEIGHT IN GR.” in understandable language and script.
17. The year of the copy, patent No., “Struck in TYRE” of the original in understandable language.
18. ETC.

[symbol]

[symbol]

[symbol]

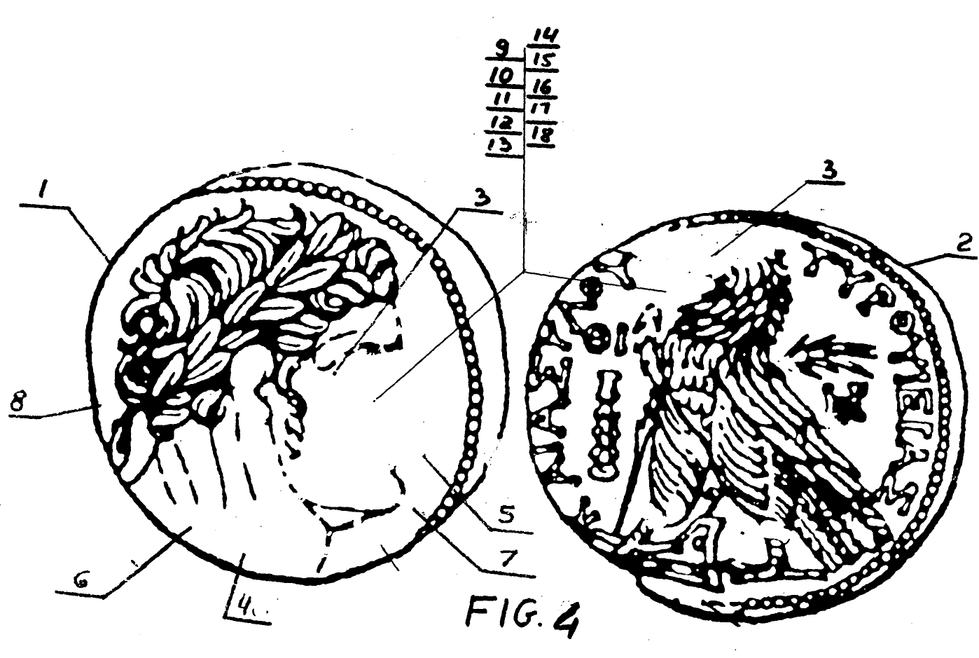

FIG. 4 shows the principles for designing a new type of holy coins: “SHEKELS AND HALF SHEKELS”.

Before the coins use to be pure weight scaled silver only. And for more accuracy Was used a “HALF SHEKEL as half from scaled one shekel. Therefore the present invention provides a pure silver weight scaled shekel standard weight which can be separated into two half of as shekels.
1. “half shekel
2. The material of the copy is silver.
3. A same image is removed by religion reason.
4. Image in original Torah script. [symbol] [symbol]
5. Image in original of the coins original script. half shekel of the sacred shekel
6. Image in original Torah script. [symbol] [symbol]
7. Image in original coin script. shekel is twenty geras
8. Image in original Torah script [symbol]
9. Hebrew year of the original in Torah script.
10. Hebrew year of the copy in Torah script.
11. Hebrew year of the original in coin script.
12. Hebrew year of the copy in coin script.
13. The year of the original in coin script.
14. The year of the copy in coin script.
15. Image “SILVER” in coin language and script.
16. “SERIAL NUMBER, PROBE, SILVER, WEIGHT IN GR.” in understandable language and script.
17. The year of the copy, patent No., “Struck in TYRE” of the original in understandable language.
ETC. [symbol] [symbol] [symbol] [symbol] [symbol] [symbol] [symbol] [symbol] [symbol] [symbol] [symbol]
   . . . , every man shall give HASHEM an atonement for his soul
   . . . , This shall they give—everyone who passes through the census—a half shekel of the sacred shekel, the shekel is twenty geras, half a shekel as a portion to HASHEM.
   . . . , shall give the portion of HASHEM . . . , to atone for your souls.
   . . . You shall take the silver of the atonements from the Children of Israel and give it . . . ; and it shall be a remembrance before HASHEM for the Children of Israel, to atone for your souls.”

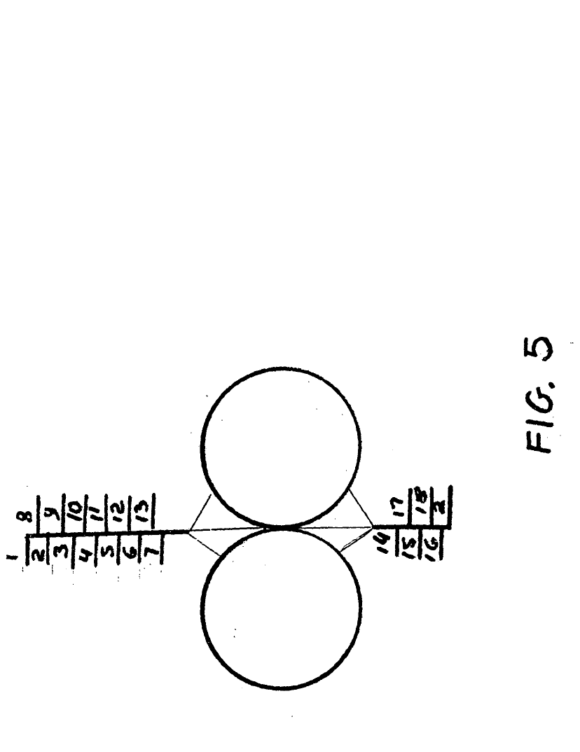

FIG. 5 shows the basic principles for designing a new coin “SHEKEL” which is a pure silver scaled 20 GERAS weight disked that can be separate into any number of geras.
1. “half shekel
2. The material of the copy is silver.
3. A same image is removed by religion reason.
4. Image in original Torah script. [symbol] [symbol]
5. Image in original of the coins original script. half shekel of the sacred shekel
6. Image in original Torah script. [symbol] [symbol]
7. Image in original coin script. shekel is twenty geras
8. Image in original Torah script [symbol]
9. Hebrew year of the original in Torah script.
10. Hebrew year of the copy in Torah script.
11. Hebrew year of the original in coin script.
12. Hebrew year of the copy in coin script.
13. The year of the original in coin script.
14. The year of the copy in coin script.
15. Image “SILVER” in coin language and script.
16. “SERIAL NUMBER, PROBE, SILVER, WEIGHT IN GR.” in understandable language and script.
17. The year of the copy patent No., “Struck in TYRE” of the original in understandable language.
18. ETC. [symbol] [symbol] [symbol] [symbol] [symbol] [symbol] [symbol] [symbol] [symbol] [symbol]
   . . . , every man shall give HASHEM an atonement for his soul
   . . . , This shall they give—everyone who passes through the census—a half shekel of the sacred shekel, the shekel is twenty geras, half a shekel as a portion to HASHEM.
   . . . , shall give the portion of HASHEM . . . , to atone for your souls.
   . . . You shall lake the silver of the atonements from the Children of Israel and give it, . . . ; and it shall be a remembrance before HASHEM for the Children of Israel, to atone for your souls.

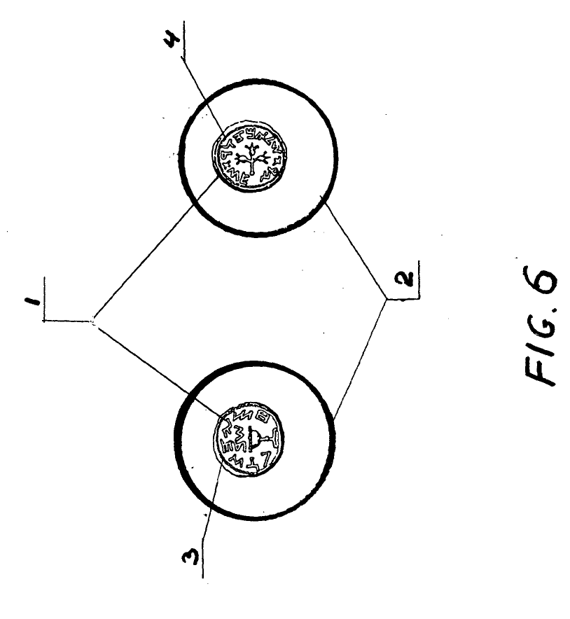

FIG. 6 shows the basic principles designing of alteration of a copy by placing the copy in center of a rim.

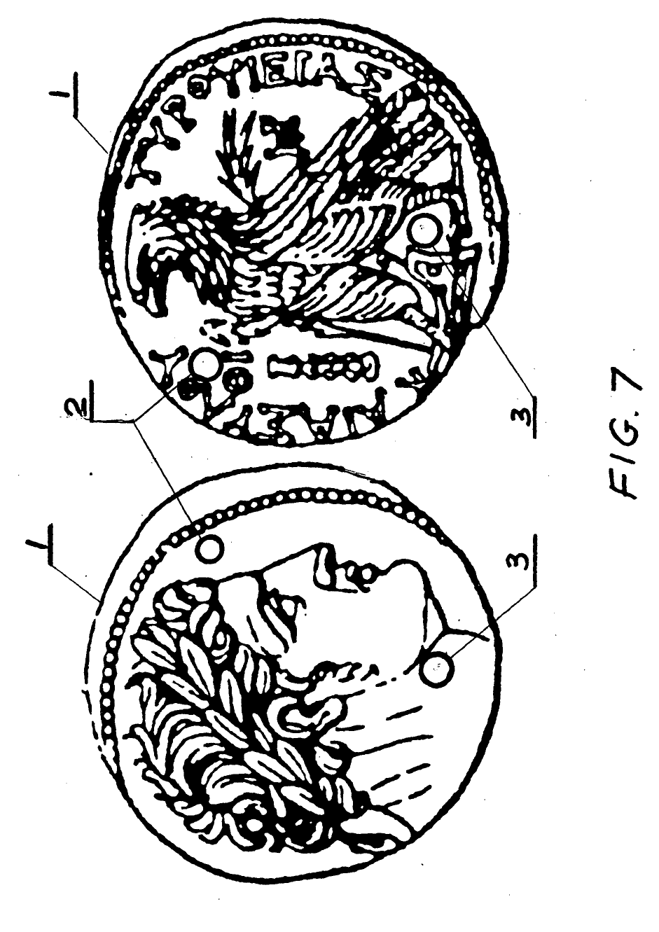

FIG. 7 shows a copy of a coin that alteration by any things. For an example alteration by any type of holes that make the copy distinguishable from original.
1 A copy of original. 2 A Hole. 3 A Hole.

1. A copy of a real antiques or coins that altered that instance of being different from the original, suitable for distinguish the article from the original means.
